(19) United States
(12) Patent Application Publication
(10) Pub. No.: US 2014/0320596 A1
(43) Pub. Date: Oct. 30, 2014

(54) Method of remote presentation of a live sporting activity

(71) Applicant: George Allen Qualls, Tampa, FL (US)

(72) Inventor: George Allen Qualls, Tampa, FL (US)

(21) Appl. No.: 13/870,875

(22) Filed: Apr. 25, 2013

(51) Int. Cl. G03H 1/08

(52) U.S. Cl. CPC G03H 1/0891
USPC 348/40

(57) ABSTRACT

A method of presenting a sporting event at a plurality of venues in real time or nearly real time. The images and sounds of persons participating in a live sporting event at a live venue are captured using a plurality of cameras and microphones. The captured images and sounds are presented at the remote venue. The captured images are presented as holographic images in real time or nearly real time using a plurality of holographic image presentation devices. The seats at the remote venue may be configured to emulate the configuration of seats at the live venue.

### FIELD OF INVENTION

The present invention relates to a method of making a remote presentation of a live sporting activity at one venue by making the sporting activity available as one or more holographic images available for viewing at one or more remote venues by viewers at the remote venues where viewers view one or more holographic images in real time or nearly real time.

### BACKGROUND OF THE INVENTION

Many live sporting events, take place in indoor or outdoor venues that can accommodate a relatively few paying patrons from the pool of persons that would like to attend the activity. Examples of appropriate sporting events are basketball games, boxing matches, martial arts competitions, and the like. While persons can sometimes observe the sporting activity on their television receiver at home, or even in a public location like a sports bar, they do not have the same vantage point and see the same images as persons at the venue of the live event.

### SUMMARY OF INVENTION

Great advances have been made in the field of capturing, transmitting and displaying holographic images. A person or organization that organizes and produces a live sporting event can significantly increase the revenue and profit generated by the event by making the event available for viewing at one or more remote venues by viewers that pay a fee to view one or more holographic images of the participants in the sporting event in real time or nearly real time.

### BRIEF DESCRIPTION OF THE DRAWINGS

FIG. 1 is a diagram representing a venue of a live sporting event.

FIG. 2 is a diagram representing the capture, transmission and presentation of holographic images of the sporting event at venues remote from the live event.

FIG. 3 is a diagram representing a venue remote from the live venue where holographic images of the e sporting event are presented in real time or nearly real time.

### DETAILED DESCRIPTION OF THE INVENTION

Holography is a technique that allows the light scattered from an object to be captured or recorded and reconstructed so that the object is in the same position relative to the recording or displaying medium as when it was recorded or captured. The image changes as position and orientation of the viewing system changes in exactly the same was as if the object were present, thus making the holographic image appear three dimensional.

Although it is an emerging technology the transmission of holographic images to remote locations is now in the realm of reality. For example the Claro holographic television described on the internet websites of Squidoo.com and Gizmag is a transparent glass television system utilizing holographic technology that displays any image fed through a projector at a specific angle on to a transparent display.

A number of patent publications disclose devices for capturing images, transmitting the captured images, and displaying the captured images as holographic images in real time or near real time. Each of the following U.S. Patents and published U.S. Patent Applications is incorporated herein in its entirety for the purpose of disclosing devices for capturing images, transmitting the captured images, and displaying the captured images as holographic images in real time or near real time for the practice of the present method of obtaining revenue: U.S. Pat. Nos. 4,376,950 A; 4,924,507 A; 5,072,215 A; 5,172,251 A; 5,227,898 A; 5,347,644 A; 5,515,183 A; 5,767,993 A; 6,078,351 A; 6,130,957 A; 6,219,435 B1; 6,999,176 B1; 2006/0055994 A1; and 2006/0187297 A1

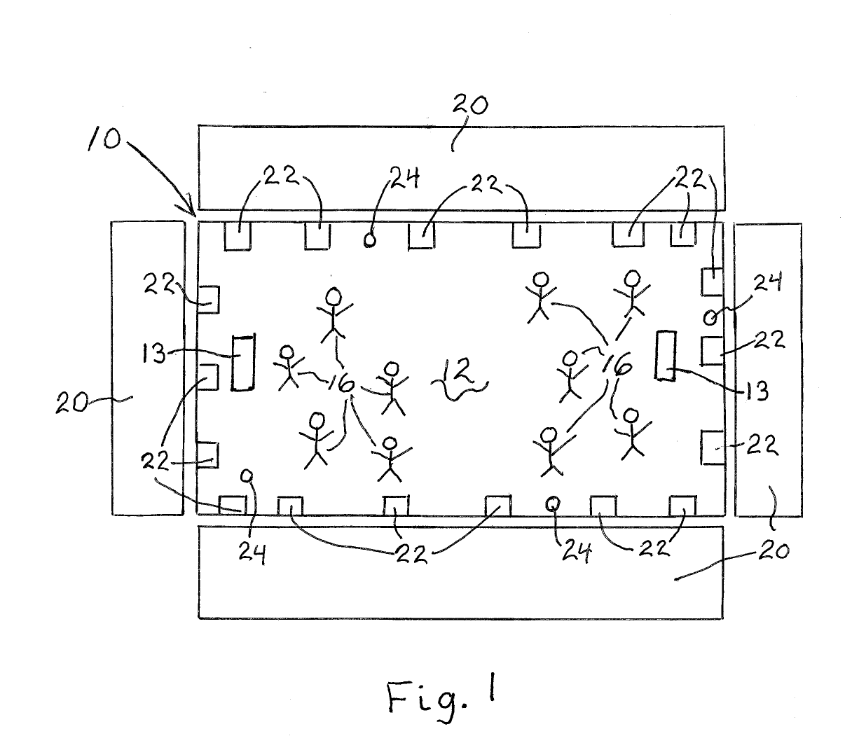

FIG. 1 is a diagrammatic representation of the venue 10 of a live indoor sporting event, in this example a basketball game. Collegiate basketball games played during conference tournaments and the national championship tournament attract a great deal of public attention, and tickets to attend these games are difficult to obtain. It is believed that many persons would gladly pay to see a better presentation of the game than is available using conventional television receivers. A basketball court 12 is rectangular with goals 13 located at each of the short ends of the rectangle. Players 16 travel between the ends of the court in an effort to score a goal for their team and prevent the opposing team from scoring a goal. Seating 20 for paying spectators at the game is normally configured along both of the long sides of the court and both of the short sides of the court.

Cameras 22 capable of capturing images of the participants 16 in the game are positioned around the court at numerous locations and various heights, possibly even overhead. Microphones 24 are positioned at numerous locations to capture the sounds generated by participants in the game, including officials and coaches.

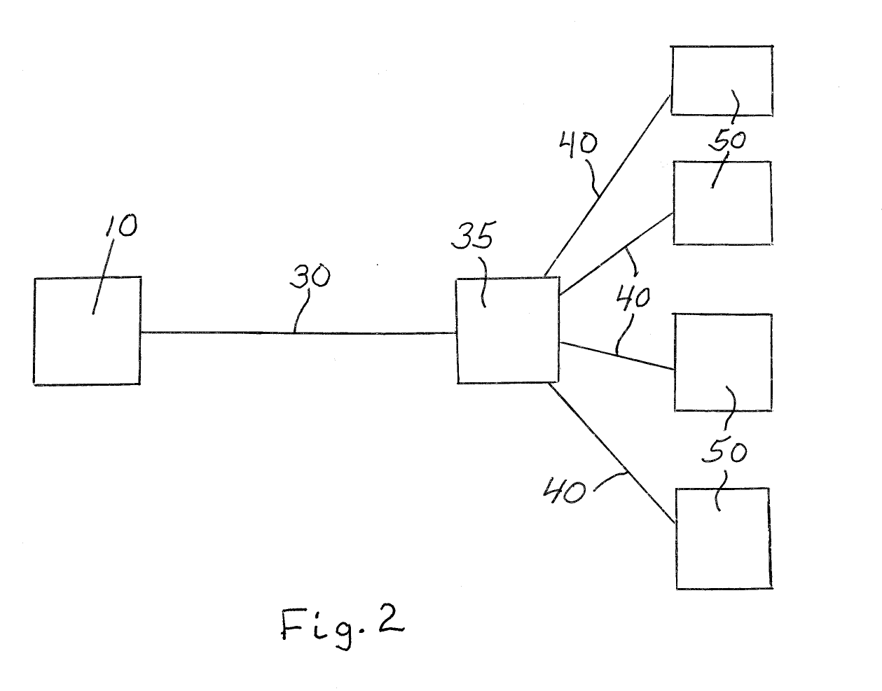

FIG. 2 is a diagrammatic representation of the operation of a method of obtaining revenue by presenting a sporting event at a plurality of venues in real time or nearly real time. A live venue is occupied by patrons that have paid a fee for entry to the live venue. Images and sounds of persons participating in a live sporting event at a live venue 10 are captured by the plurality of cameras 22 and microphones 24 as set forth above with respect to FIG. 1. The images and sounds captured by the cameras and microphones at the live venue 10 are transmitted via a suitable transmission system 30, such as fiber optics, the internet or even radio or television waves, to a unit 35 that processes the captured images and sounds into signals for holographic presentations. The holographic presentations comprising the captured images and sounds from the live venue 10 are transmitted via a suitable transmission system 40, such as fiber optics, the internet or even radio or television waves, to at least one remote venue 50 that is occupied by patrons that have paid a fee for entry to the at least one remote venue. The captured images are transmitted as electronic signals to one or more signal processing devices that process the signals to produce holographic images of the persons participating in the live event. The processing devices may be located at the venue of the live event, at each remote venue, or at a central location 35 that receives the signals, transforms the signals to new signals that are presentable as holographic images, and then sends the transformed signals to each of the remote locations 50. The signal transmission and processing scheme selected is dependent upon the technology employed.

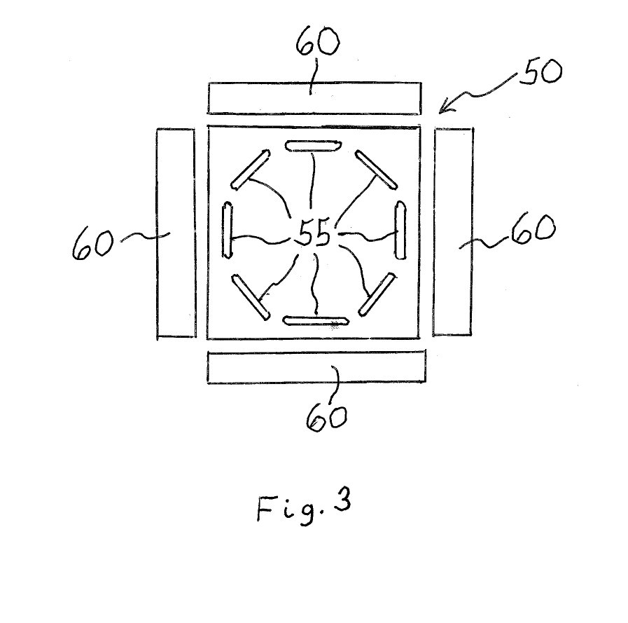

FIG. 3 is a diagrammatic representation of a remote venue 50 for presenting the images and sounds captured at the live venue, wherein the captured images are presented as holographic images in real time or nearly real time using a plurality of holographic image presentation devices 55. The patrons at the remote venue are provided with suitable seating 60 and may be charged an admission fee to generate revenue. As used herein and in the claims the term “nearly real time” is understood to be a very short delay on the order or seconds or milliseconds. Preferably the remote venue 50 is an indoor venue. Preferably the remote venue is provided with seats 60 disposed in a configuration that emulates the configuration of the seats at the live venue. A plurality of devices 55 that display holographic images are located in a formation that emulates what a person sitting in an analogous location at the live venue sees as the event takes place. A paying patron at a remote venue has a viewing experience that is much more like being at the venue of the live event than is possible with other technologies.

It is to be understood that the following claims are intended to cover all of the generic and specific features of the invention herein described, and all statements of the scope of the invention which, as a matter of language, might be said to fall there between.

What is claimed is:

1. A method of presenting a sporting event at a plurality of venues in real time or nearly real time, comprising the steps of:
capturing the images and sounds of persons participating in a live sporting event at a live venue using a plurality of cameras and microphones;
transmitting the captured images and sounds to at least one remote venue;
presenting the captured images and sounds at the at least one remote venue wherein the captured images are presented as holographic images in real time or nearly real time using a plurality of holographic image presentation devices.

2. The method of presenting a sporting event at a plurality of venues in real time or nearly real time according to claim wherein the live sporting event is conducted indoors.

3. The method of presenting a sporting event at a plurality of venues in real time or nearly real time according to claim 1 wherein the sporting event is conducted indoors and each of the at least one remote venues is an indoor venue.

4. The method of presenting a sporting event at a plurality of venues in real time or nearly real time according to claim 1 wherein the live venue is provided with seats disposed in a seating configuration, and at least one remote venue is provided with seats disposed in a configuration that emulates the configuration of the seats at the live venue.

5. The method of presenting a sporting event at a plurality of venues in real time or nearly real time according to claim 2 wherein the live venue is provided with seats disposed in a seating configuration, and at least one remote venue is provided with seats disposed in a configuration that emulates the configuration of the seats at the live venue.

6. The method of presenting a sporting event at a plurality of venues in real time or nearly real time according to claim 3 wherein the live venue is provided with seats disposed in a seating configuration, and at least one remote venue is provided with seats disposed in a configuration that emulates the configuration of the seats at the live venue.

7. A method of presenting a basketball game at a plurality of venues in real time or nearly real time, comprising the steps of:
capturing the images and sounds of persons participating in a live basketball game at a live venue using a plurality of cameras and microphones;
transmitting the captured images and sounds to a plurality of remote venues;
presenting the captured images and sounds at the remote venues wherein the captured images are presented as holographic images in real time or nearly real time using a plurality of holographic image presentation devices.

8. The method of presenting a basketball game at a plurality of venues in real time or nearly real time according to claim 7 wherein the live venue is provided with seats disposed in a seating configuration, and at least one of the remote venues is provided with seats disposed in a configuration that emulates the configuration of the seats at the live venue.
